(19) United States
(12) Patent Application Publication
(10) Pub. No.: US 2025/0360056 A1
(43) Pub. Date: Nov. 27, 2025

(54) ANTI-PROTRUDING TEETH PACIFIER AND BOTTLE NIPPLE THEREOF

(71) Applicant: Fu-Yi LIN, Taipei (TW)

(72) Inventors: Fu-Yi LIN, Taipei (TW); Tzu-Yu CHEN, Taipei (TW)

(21) Appl. No.: 18/865,669

(22) PCT Filed: May 20, 2022
(86) PCT No.: PCT/CN2022/094096

§ 371 Date: Jul. 2, 2025

(51) Int. Cl. A61J 17/00; A61J 11/00

(52) U.S. Cl. CPC A61J 17/107; A61J 11/007; A61J 17/001

(57) ABSTRACT

Provided are an anti-snaggletooth pacifier and a nipple for a feeding bottle thereof, comprising: a teat sleeve portion (13) having a teat member (132), one end of the teat member (132) being connected to a handle portion (133); a dental arch sleeve portion (11), the teat sleeve portion (13) being connected to an upper side of the dental arch sleeve portion (11) by means of the handle portion (133); and a tongue sleeve portion (12), a tongue pad cavity (120) being formed between the tongue sleeve portion (12) and the teat sleeve portion (13), and the tongue sleeve portion (12) being connected to a lower side of the dental arch sleeve portion (11). The tongue of a baby is accommodated by the tongue sleeve portion (12), so that the tongue is fixed and pressed upwards, thus avoiding that the tongue retracts downwards for a long term and thus the tooth arch is shrunk to cause the development of snaggletooth and dental occlusion deformation in the tooth growth process.

### FIELD OF THE INVENTION

The present invention relates to a pacifier, particularly an anti-overbite pacifier and its associated pacifier for baby bottles.

### BACKGROUND

During the growth of children's teeth, due to a narrow dental arch in the mouth, the first permanent teeth begin to emerge around the age of six, gradually leading to malocclusion issues such as: crowding, cross-bite, deep bite, protruding teeth, insufficient upper jaw development, and more. The narrow dental arch in children is often associated with thumb-sucking and pacifier use. When children suck their thumb or a pacifier, the muscles on both sides of the cheeks exert prolonged inward pressure on the dental arch, causing it to become narrow.

Additionally, during the growth of children's teeth, a narrow upper dental arch can lead to breathing through the mouth instead of the nose due to nasal congestion or allergies. With the mouth open, the cheek muscles exert pressure on the inner teeth, while the tongue cannot support the upper jaw, leading to excessive inward pressure on the teeth and a narrower dental arch. The dental arch in the mouth is typically U-shaped or elliptical, and is categorized into the upper and lower arches. Misalignment of teeth during growth is due to insufficient space for development: a significantly constricted arch can take on an inward V shape, lacking the space needed for proper alignment and occlusion.

In existing technology, once a child's teeth have matured past the age of twelve, the shape of the dental arch is largely fixed, making it difficult to correct through lifestyle changes. Misaligned teeth can affect facial aesthetics and chewing functionality. The lack of uniform alignment is a result of inadequate growth space, and under narrow arch conditions, the teeth cannot align properly. Existing technology allows for the expansion of the dental arch to increase space for the growth of the upper teeth, addressing issues like crowding, cross-bites, and insufficient upper jaw development. Therefore, for children whose dental development has surpassed the age of twelve, correction can only be achieved through dental arch expansion or extraction.

Existing surgical techniques for arch expansion can be categorized into rapid and slow expansion methods based on the rate of tooth movement. Slow expansion may take six months to two years, while rapid expansion can be completed within one to three months. Following arch expansion surgery, patients often still need to wear braces to fully correct alignment and occlusion issues.

In existing technology, rapid expansion devices are installed in the upper teeth and utilize screw mechanisms to open the midpalatine suture of the upper jaw. Surgery is typically performed when children are between seven and nine years old after the emergence of their first molars and premolars. For individuals over fifteen to seventeen years old, since the suture of the upper jaw is largely fused by this age, surgical intervention to cut through the cortical bone is required to assist rapid expansion.

Slow expansion devices are classified into fixed and movable types. Fixed slow expansion employs various arch wires to apply corrective forces to move the teeth, while movable slow expansion involves wearing soft dental trays that apply corrective forces through different-shaped trays. However, slow expansion cannot open the midpalatine suture but only moves the teeth with limited expansion.

### SUMMARY OF THE INVENTION

The purpose of the present invention is to provide an anti-overbite pacifier and its associated pacifier for baby bottles, which can be used from the ages of one to three to prevent the long-term retraction of the tongue and inward pressure from the cheeks that may cause narrowing of the dental arch in infants, leading to overbite and deformation during tooth growth.

The technical means of this invention is an anti-overbite pacifier, which includes: a nipple sleeve with a nipple part: a dental arch sleeve connected to the upper side of the nipple sleeve via a handle; and a tongue sleeve that forms a cavity between the tongue sleeve and the nipple sleeve, connecting to the lower side of the dental arch sleeve.

In an embodiment of the invention, the nipple sleeve also includes a suction hole through the nipple part. The anti-overbite pacifier is selected from structures that include a lip shield and those that do not include at least one such structure. The anti-overbite pacifier is structured with a lip shield that is connected to the dental arch sleeve through a coupling piece.

In another embodiment of the invention, the dental arch sleeve includes: a dental guide piece: an upper front arch component connected to the upper edge of the dental guide piece: an upper rear arch component connected to the rear edge of the dental guide piece, forming a U-shaped upper arch groove for accommodating the upper gums; and a lower front arch component connected to the lower edge of the dental guide piece. Additionally, the upper front arch component has two upper arch protrusions and one upper arch recess to accommodate the muscle connection between the upper lip and the upper gums.

In another embodiment, the tongue sleeve includes a right tongue pad connected to the lower rear edge of the dental guide piece and a left tongue pad connected to the lower rear edge of the dental guide piece, with a tongue pad groove seam between the right and left tongue pads. A tongue pad cavity is formed between the right tongue pad, the left tongue pad, and the nipple sleeve to accommodate a tongue. A U-shaped lower arch groove is also formed between the dental guide piece and the right and left tongue pads to accommodate the lower gums.

The technical means also include an anti-overbite pacifier for baby bottles, which consists of: an anti-overbite pacifier installed on a baby bottle. The anti-overbite pacifier includes a nipple sleeve, a dental arch sleeve, and a tongue sleeve. The pacifier for the baby bottle may have at least one structure with a connection part or may lack it, with the structure having a connection part connected to the dental arch sleeve. One end of the connection part connects to the dental arch sleeve, while the other end has a flange that seals the bottle's opening with a cap. When the pacifier for the baby bottle does not have the connection part, it connects to the dental arch sleeve through a straw, with the other end of the straw connecting to the bottle.

In another embodiment, the anti-overbite pacifier for baby bottles includes: a nipple sleeve with a nipple part having a suction hole, with one end connected to a handle: a dental arch sleeve connected to the upper side of the nipple sleeve via the handle; and a tongue sleeve connected to the lower side of the dental arch sleeve.

In another embodiment, the dental arch sleeve includes: a dental guide piece: an upper front arch component connected to the upper edge of the dental guide piece: an upper rear arch component connected to the rear edge of the dental guide piece, forming a U-shaped upper arch groove for accommodating the upper gums; and a lower front arch component connected to the lower edge of the dental guide piece. The upper front arch component has two upper arch protrusions and one upper arch recess to accommodate the muscle connection between the upper lip and the upper gums.

In another embodiment, the tongue sleeve includes: a right tongue pad connected to the lower rear edge of the dental guide piece; and a left tongue pad connected to the lower rear edge of the dental guide piece, with a seam between the right and left tongue pads. A tongue pad cavity is formed between the right tongue pad, left tongue pad, and the nipple sleeve to accommodate a tongue, with a U-shaped lower arch groove formed between the dental guide piece and the right and left tongue pads to accommodate the lower gums.

In another embodiment, the inner layer of the dental guide piece has at least one fluid channel, one end of which connects to the straw and the other end connects to the nipple sleeve.

In another embodiment, the nipple sleeve and the handle internally have at least another fluid channel that connects the fluid channel in the nipple sleeve to the fluid channel in the dental guide piece for transmitting liquid from the bottle to the suction hole.

The present invention provides an anti-overbite pacifier and its baby bottle pacifier with a tongue sleeve that can accommodate an infant's tongue, fixing the tongue against the upper jaw of the mouth to avoid long-term retraction of the tongue and inward pressure from the cheeks, which may lead to a narrowed dental arch and cause overbite and deformation during the growth of children's teeth. Therefore, this invention aims to provide adequate expansion space for the dental arch in infants, avoiding narrowing and deformation of the arch, thus resolving the disadvantages of existing technology and reducing the time and costs required for subsequent dental correction during growth.

### BRIEF DESCRIPTION OF THE DRAWINGS

FIG. 1A is a perspective view of the anti-overbite pacifier from the front:

FIG. 1B is a top-down view of the anti-overbite pacifier from the left;

FIG. 1C is a top-down view of the anti-overbite pacifier from the right;

FIG. 2 is a perspective view of the anti-overbite pacifier from the left:

FIG. 3A is a right-side view of the anti-overbite pacifier:

FIG. 3B is a bottom view of the anti-overbite pacifier:

FIG. 3C is a top view of the anti-overbite pacifier:

FIG. 3D is a front view of the anti-overbite pacifier:

FIG. 3E is a rear view of the anti-overbite pacifier:

FIG. 4 is a diagram showing the anti-overbite pacifier placed in the mouth;

FIG. 5 shows the anti-overbite pacifier for baby bottles placed in the mouth;

FIG. 6 illustrates the anti-overbite pacifier with a lip shield:

FIG. 7 shows the anti-overbite pacifier for baby bottles with the connection part structure.

### REFERENCE MARK EXPLANATION

pacifier for preventing buck teeth (10): arch sleeve section (11): tongue sheath (12): front upper arch element (111): U-shaped upper arch groove (112); rear upper arch element (113): U-shaped lower arch groove (114); front lower arch element (115): upper arch groove (116): upper arch projection (117): dental tray (118): tongue sheath (12): tongue pad cavity (120): left tongue pad element (121); right tongue pad element (122): tongue pad groove slot (123); nipple sheath (13); suction hole (131); nipple element (132); handle (133); air chamber (134); lip shield (14); hanging ring (141): coupling component (142): connection par (15); flange (151); opening (152): nasal cavity (2); upper lip (31); lower lip (32); upper gum (33); lower gum (34); tongue (35); nasal tip (5); jaw (6); feeding bottle (71); bottle cover (72); straw (73); sleeve cover (74).

### DETAIL DESCRIPTION

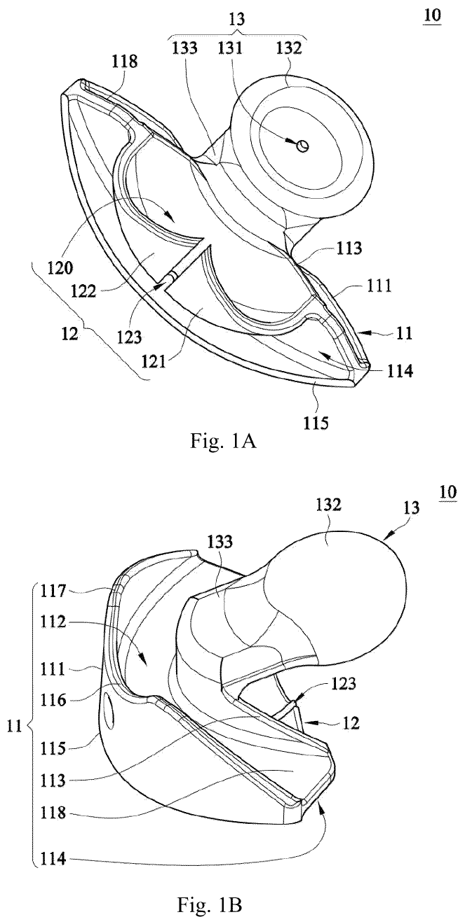

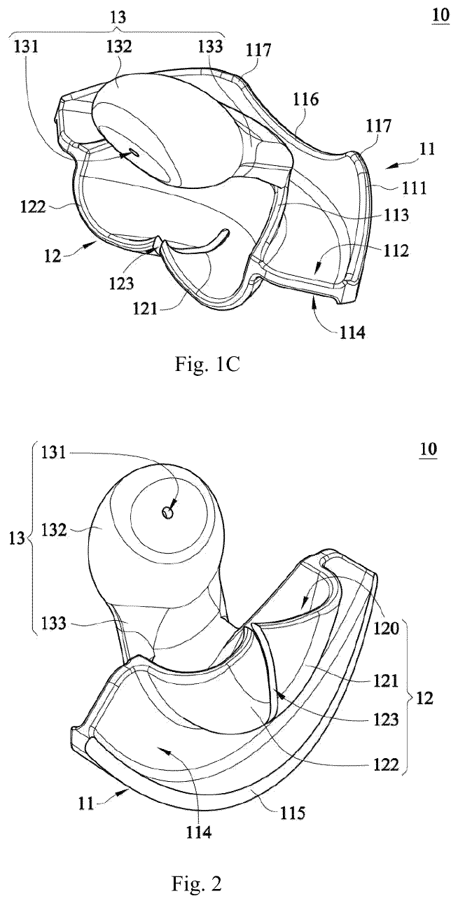

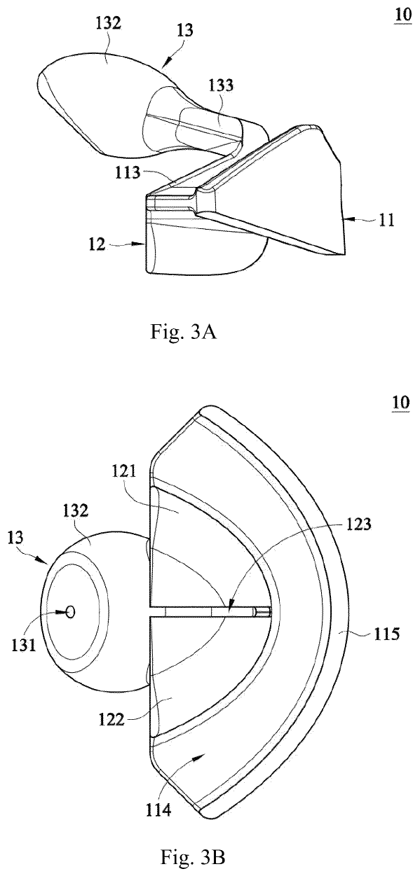

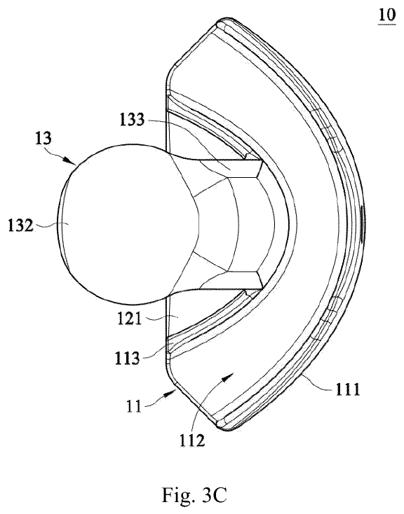

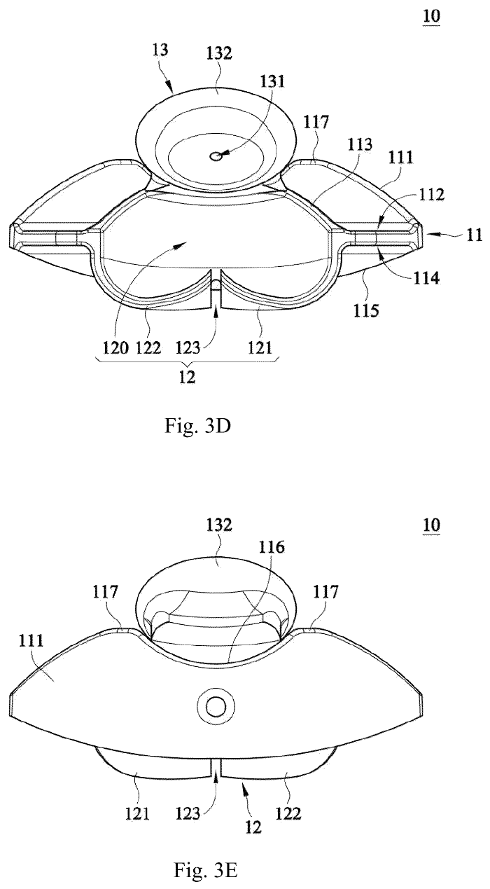

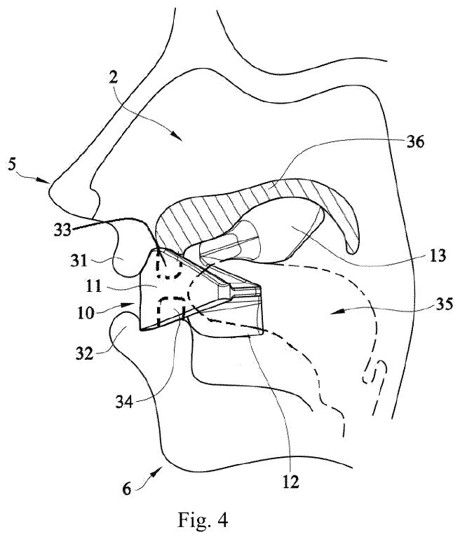

As shown in FIGS. 1 to 7, a pacifier for preventing buck teeth (10) according to an illustration of this invention is described below.

The pacifier for preventing buck teeth (10) may feature either a structure with a lip shield (14) or without one, including at least one of these configurations. The structure with a lip shield (14) includes a lip shield (14) along with a nipple sheath (13), an arch sheath (11), and a tongue sheath (12). The lip shield (14) is connected to the arch sheath (11) via a coupling component (142), which may be an air chamber structure.

The nipple sheath (13) includes a nipple element (132), with one end of this nipple element (132) connected to a handle (133). The nipple element (132) may include an air chamber (134). The nipple sheath (13) is connected to the upper side of the arch sheath (11) through the handle (133), forming a cavity between the tongue sheath (12) and the nipple sheath (13). The tongue sheath (12) is attached to the lower side of the arch sheath (11). Additionally, the nipple sheath (13) includes a suction hole (131) that passes through the nipple element (132).

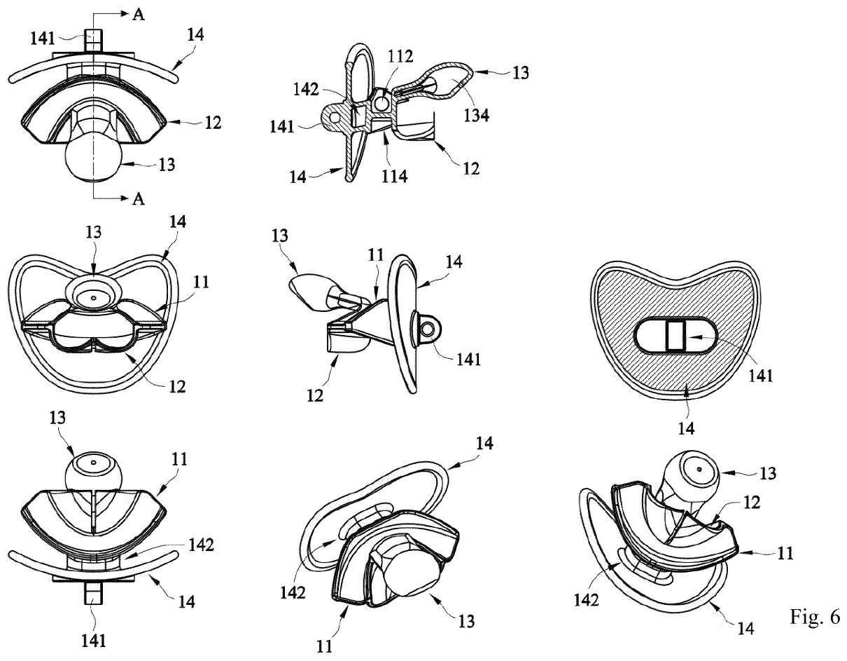

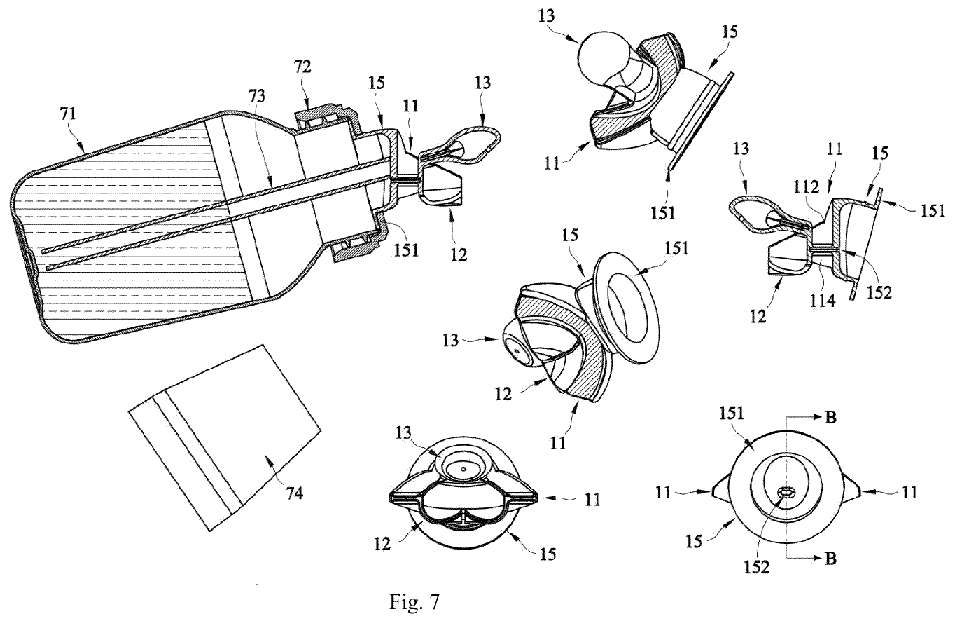

As shown in FIGS. 6 and 7, the pacifier for preventing buck teeth (10) further includes representations of the nasal cavity (2), upper lip (31), lower lip (32), upper gum (33), lower gum (34), tongue (35), nasal tip (5), and chin (6), positioned as marked in the figures. Other components, such as the hanging ring (141), opening (152), and the sleeve cover (74), are also positioned as indicated in FIGS. 6 and 7.

In one configuration of the pacifier for preventing buck teeth (10) shown in FIGS. 1 to 7, the arch sheath (11) includes: a dental tray (118), a front upper arch element (111), a rear upper arch element (113), and a front lower arch element (115). The front upper arch element (111) is connected to the upper side of the front edge of the dental tray (118). The rear upper arch element (113) connects to the rear edge of the dental tray (118), forming a U-shaped upper arch groove (112) with the front upper arch element (111) and the rear upper arch element (113) to accommodate the upper gum (33). Additionally, the front lower arch element (115) is connected to the lower side of the front edge of the dental tray (118). The front upper arch element (111) of the arch sheath (11) features two upper arch projections (117) and an upper arch groove (116), to accommodate the muscle connecting the upper lip (31) and the upper gum (33).

The objective and effect of this invention are to provide an infant with a combined nipple sheath (13) and tongue sheath (12) at an early age, enhancing the infant's tongue (35) to press against the palate, thereby preventing the arch from shrinking. This avoids issues like protruding teeth and malocclusion resulting from reduced arch space as the teeth develop. The invention serves as both an artificial nipple for the nipple sheath (13) and a positioning function for the tongue sheath (12), which supports the tongue (35) against the upper palate. The tongue sheath (12) accommodates the infant's tongue (35), keeping it positioned against the palate and preventing arch shrinkage caused by prolonged retraction of the tongue (35) or inward force from the cheeks.

FIGS. 1 to 7 illustrate an illustration of the pacifier for preventing buck teeth (10) with a tongue sheath (12) that includes a right tongue pad element (122) and a left tongue pad element (121). The right tongue pad element (122) is attached to the lower side of the rear edge of the dental tray (118), as is the left tongue pad element (121). A tongue pad groove slot (123) exists between the right and left tongue pad elements (122, 121). Together, the right tongue pad element (122), left tongue pad element (121), and nipple sheath (13) form a tongue pad cavity (120), where the infant's tongue (35) is positioned against the palate to prevent prolonged tongue retraction (35). Additionally, a U-shaped lower arch groove (114) is formed between the dental tray (118), right tongue pad element (122), and left tongue pad element (121) to accommodate the lower gum (34). Through the biting of the infant's upper and lower gums (33, 34), the lower and upper arch grooves (114, 112) provide a pre-expansion positioning effect for the infant arch expander.

According to one illustration, as shown in FIGS. 1 to 7, the pacifier for preventing buck teeth also includes a feeding bottle nipple with anti-buck teeth functionality. The pacifier (10) is mounted on a feeding bottle (71), which is connected to the pacifier (10) by a straw (73). This pacifier for preventing buck teeth enhances the infant's tongue (35) pressing against the palate by combining the nipple sheath (13) and tongue sheath (12) while the infant sucks on the artificial nipple and liquid nutrients, thereby serving as a preventive alignment for buck teeth.

In the illustration shown in FIGS. 1-5, the inner layer of the dental tray (118) includes at least one fluid channel (not shown), with one end connected to the straw (73) and the other end leading to the nipple sheath (13). Additionally, there are further fluid channels within the nipple element (132) and handle (133) of the nipple sheath (13). The fluid channel in the nipple sheath (13) connects to the fluid channel in the dental tray (118) to convey liquid from the feeding bottle (71) to the suction hole (131).

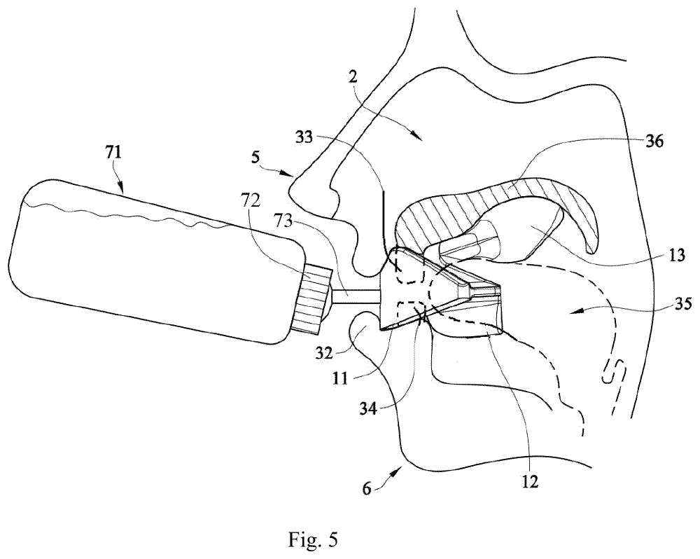

As depicted in FIG. 5, this illustration includes a version of the pacifier without the lip shield (14), as shown in FIGS. 1 to 4, with the same structural components: a nipple sheath (13), arch sheath (11), and tongue sheath (12). The nipple sheath (13) has a nipple element (132), with one end connected to a handle (133), which links the nipple sheath (13) to the upper side of the arch sheath (11). The tongue sheath (12) and nipple sheath (13) form a cavity, with the tongue sheath (12) connecting to the lower side of the arch sheath (11). The nipple sheath (13) also includes a suction hole (131) in the nipple element (132).

In the illustration shown in FIG. 5, the pacifier for the feeding bottle incorporates the pacifier described in FIGS. 1 to 4, including the dental tray (118), front and rear upper arch elements (111, 113), and front lower arch element (115) forming the U-shaped upper arch groove (112) and lower arch groove (114) to accommodate the gums (33, 34) and provide pre-expansion positioning for infant arch development.

This invention allows additional modifications based on the claims and descriptions provided above, without departing from its essential spirit and scope.

What is claimed is:

1. An anti-protruding teeth pacifier, wherein comprises:
a nipple sleeve section with a nipple component, where one end of the nipple component connects to a handle part;
an arch sleeve section, where the nipple sleeve section connects to an upper side of the arch sleeve section through the handle part; and
a tongue sleeve section that forms a tongue pad cavity between the tongue sleeve section and the nipple sleeve section, with the tongue sleeve section connected to the lower side of the arch sleeve section.

2. The anti-protruding teeth pacifier according to claim 1, wherein the presence of either a lip shield or the absence thereof; when equipped with the lip shield, the lip shield connects to the arch sleeve section through a coupling part.

3. The anti-protruding teeth pacifier according to claim 2, wherein the arch sleeve section comprises:
a dental tray;
an upper front arch part connected to the upper side of the dental tray's front edge;
an upper rear arch part connected to the rear edge of the dental tray, forming a U-shaped upper arch groove with the upper front arch part and the upper rear arch part for fitting and housing the upper gums; and
a lower front arch part connected to the lower side of the dental tray's front edge.

4. The anti-protruding teeth pacifier according to claim 3, wherein the tongue sleeve section comprises:
a right tongue pad component connected at one end to the lower side of the rear edge of the dental tray; and
a left tongue pad component connected at one end to the lower side of the rear edge of the dental tray, with a tongue pad groove slot between the right and left tongue pad components;
wherein the tongue pad cavity formed between the right tongue pad component, the left tongue pad component, and the nipple sleeve section, to accommodate a tongue; a U-shaped lower arch groove is also formed between the dental tray, the right tongue pad component, and the left tongue pad component for fitting and housing the lower gums.

5. An anti-protruding teeth pacifier bottle nipple, which comprises the anti-protruding teeth pacifier as described in claim 1, wherein the anti-protruding teeth pacifier is attached to a bottle, having a nipple sleeve section, an arch sleeve section, and a tongue sleeve section; where the pacifier bottle nipple may include either a coupling part or lack thereof, and when the pacifier bottle nipple comprises a coupling part, one end of the coupling part is connected to the arch sleeve section, while the other end features a flange, with the flange pressing against the bottle opening through a cap. If lacking the coupling part, the nipple connects to the arch sleeve section via a straw.

6. The anti-protruding teeth pacifier bottle nipple according to claim 5, wherein the arch sleeve section comprises:
a dental tray;
an upper front arch part connected to the upper side of the front edge of the dental tray;
an upper rear arch part connected to the rear edge of the dental tray, forming a U-shaped upper arch groove with the upper front and rear arch parts for fitting and housing the upper gums; and
a lower front arch part connected to the lower side of the dental tray's front edge.

7. The anti-protruding teeth pacifier bottle nipple according to claim 6, wherein the tongue sleeve section comprises:
a right tongue pad component connected at one end to the lower side of the rear edge of the dental tray;
a left tongue pad component connected at one end to the lower side of the rear edge of the dental tray, with a tongue pad groove slot between the right and left tongue pad components; and
a tongue pad cavity formed between the right tongue pad component, the left tongue pad component, and the nipple sleeve section, to accommodate a tongue; a U-shaped lower arch groove is also formed between the dental tray, the right tongue pad component, and the left tongue pad component for fitting and housing the lower gums.

8. The anti-protruding teeth pacifier bottle nipple according to claim 7, wherein the inner layer of the dental tray comprises at least one fluid channel, with one end of the fluid channel connecting to the straw, and the other end connecting to the nipple sleeve section.

9. The anti-protruding teeth pacifier bottle nipple according to claim 8, wherein the internal sections of the nipple component and the handle part of the nipple sleeve section include at least one other fluid channel, connecting the fluid channels in the nipple sleeve section and the dental tray to transport liquid from the bottle to the suction hole.
